(19) United States
(12) Patent Application Publication
(10) Pub. No.: US 2001/0021636 A1
(43) Pub. Date: Sep. 13, 2001

(54) Heating, ventilation and/or air-conditioning device including at least one element for diffusing air into the passenger compartment of a vehicle

(76) Inventors: Carine Paumier, Versailles (FR); Pascale Petitjean, Neauphle le Vieux (FR); Didier Loup, Maurepas (FR)

Correspondence Address: Liniak, Berenato, Longacre & White, Suite 240, 6550 Rock Spring Drive, Bethesda, MD, 20817, US

(21) Appl. No.: 09/799,104

(22) Filed: Mar. 6, 2001

(30) Foreign Application Priority Data
Mar. 6, 2000 (FR) 0002833

(51) Int. Cl. B60H 1/34

(52) U.S. Cl. 454/152

(57) ABSTRACT

A heating, ventilation and/or air-conditioning device includes an air-distribution channel having a downstream end, and an air-diffusion element at the downstream end. The air-diffusion element includes a support with through-apertures, covered on at least one of its faces with a material, having an air resistance lying between 10 N.s.m⁻³ and 180 N.s.m⁻³.

### FIELD OF THE INVENTION

The present invention relates to a heating, ventilation and/or air-conditioning device including at least one air-distribution channel having a downstream end, and at least one air-diffusion element arranged at a said downstream end, in order to diffuse air into the passenger compartment of a vehicle.

### BACKGROUND OF THE INVENTION

The diffusion of air into the passenger compartment of a vehicle is usually by way of a plurality of vents. These installations exhibit drawbacks: they cause air currents and poor distribution of temperature in the passenger compartment, which impairs the comfort of the passengers.

In order to remedy this problem, one known solution consists in diffusing the air through a porous surface which extends over the dashboard. These porous surfaces are generally obtained by providing a large number of holes of small dimensions piercing through a surface impermeable to air, as mentioned in the French Patent Application FR 2 074 471 and in the British Patent GB 1 040 469.

In the known devices, the porous surfaces are either too porous, in which case the throughput of air in the air-diffusion vents associated with the diffusion is too high, or insufficiently porous, in which case the loss of pressure head is too high and the dynamic range for temperature-setting of the passenger compartment is too small and its effect is not felt in a satisfactory way by the passengers.

The subject of the present invention is a heating, ventilation and/or air-conditioning device which makes it possible to get round this problem and to obtain a regular air diffusion which provides effective temperature-setting of the passenger compartment while avoiding causing the abovementioned phenomena of air currents.

### SUMMARY OF THE INVENTION

According to the present invention there is provided a heating, ventilation and/or air-conditioning device including at least one air-distribution channel having a downstream end, and at least one air-diffusion element arranged at a said downstream end, wherein at least one air-diffusion element exhibits air resistance lying between 10 N.s.m⁻³ and 180 N.s.m⁻³.

In a specific embodiment, there is provided a heating, ventilation and/or air-conditioning device including at least one air-distribution channel having a downstream end, and at least one air-diffusion element arranged at a said downstream end, wherein at least one said air-diffusion element having, for example, a surface area lying between 0.02 m² and 0.5 m², and preferably 0.04 m² and 0.2 m², includes a support provided with through-apertures, and covered on at least one of its faces with a material having an air resistance lying between 10 N.s.m⁻³ and 180 N.s.m⁻³.

The said air resistance is advantageously less than 80 N.s.m⁻³.

The material may be a textile, especially a multi-layered textile.

The textile and the support may advantageously be integrated by thermal bonding.

It is advantageous for the support to be rigid or semi-rigid.

According to a preferred embodiment, the support is thermoformed.

The support may, for example, be a honeycomb.

The invention also relates to a heating, ventilation and/or air-conditioning device including at least one air-distribution channel having a downstream end, and at least one air-diffusion element arranged at a said downstream end, characterized in that at least one said air-diffusion element having, for example, a surface area lying between 0.02 m² and 0.5 m² and preferably 0.04 m² and 0.2 m², exhibits an air resistance lying between 10 N.s.m⁻³ and 180 N.s.m⁻³.

The said air resistance is advantageously less than 80 N.s.m⁻³.

The air-diffusion element may, in particular, include a perforated plate, a grille, a cellular plastic with open pores or an alveolar material.

It is advantageous for the air-diffusion element to include at least one textile.

The air-diffusion element may include a rigid or semi-rigid support for the said textile.

The support may, for example, be a perforated plate.

It is advantageous for the support to feature an air resistance no more than half of, and preferably at least ten times lower than, that of the said textile.

According to a preferred embodiment, the support exhibits through-apertures.

The textile may be woven or else non-woven, for example a velour.

The textile may be multi-layered.

### BRIEF DESCRIPTION OF THE DRAWINGS

Other characteristics and advantages of the invention will emerge better on reading the description which will follow, given by way of non-limiting example, in connection with the attached drawings, in which:

FIG. 1 represents a view of the dashboard of a vehicle equipped with a device according to the present invention;

FIG. 2 represents a sectional view of an example embodiment of a composite panel according to the invention;

FIG. 3 represents a sectional view in perspective of an embodiment of a composite panel according to the invention;

FIGS. 4a to 4d represent embodiments of supports with through-alveoli according to embodiments of the invention;

FIG. 5 represents a graph of loss of pressure head as a function of the throughput of a device according to the invention.

### DESCRIPTION OF THE PREFERRED EMBODIMENTS

In the various figures, like reference numerals refer to like parts.

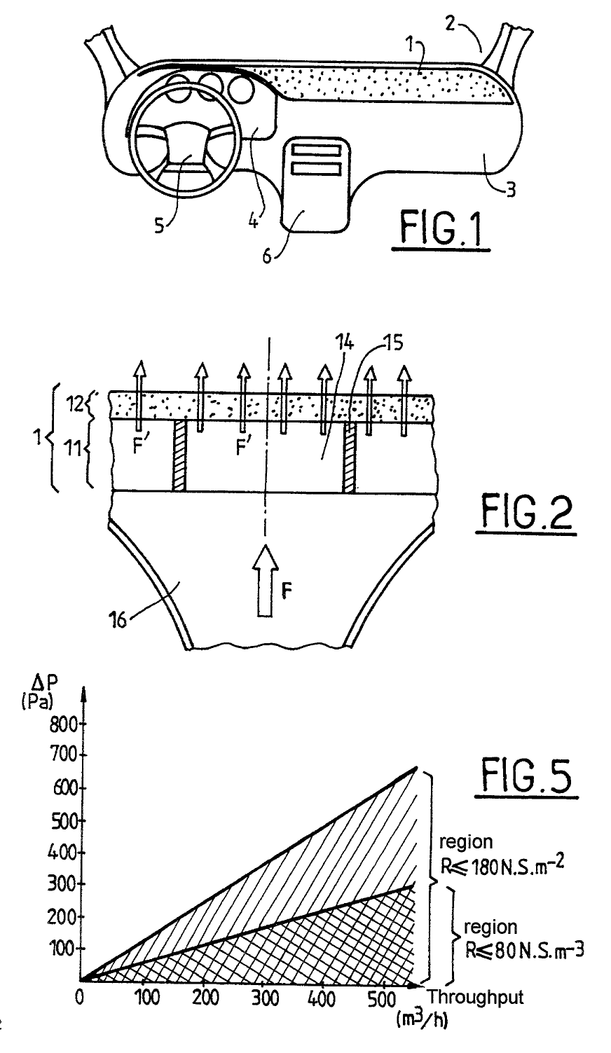

The dashboard 3 represented in FIG. 1 includes a fascia 3, an instrument panel 4, a steering wheel 5, a console 6 and, at the upper part of the dashboard 3, and juxtaposed with the windscreen 2, a surface-mounted air-diffusion element 1 which extends, for example, over the entire width of the vehicle, and which makes it possible to achieve a distributed air diffusion, at low surface throughput, so as to achieve air diffusion without any air current being perceptible by the passengers and with a uniform distribution of the temperature in the passenger compartment of the vehicle.

The air diffusion is provided by a material, especially a textile, having an air resistance lying between 10 N.s.m⁻³ and 180 N.s.m⁻³. In particular, the use of a woven or non-woven textile is particularly advantageous in the sense that it allows a truly surface-acting and homogeneous diffusion while making it possible to produce a trim covering of the dashboard which is compatible with the aesthetic requirements of the stylists.

For small vehicles, in which the passenger compartment is compact (for example, two-seat vehicles, town vehicles), a higher loss of pressure head is allowable on passing through the textile 12. The latter may have a high air resistance, but below 180 N.s.m⁻³, which allows a dynamic range for setting the temperature of the passenger compartment which is satisfactory for the comfort of the passengers.

For vehicles in which the passenger compartment is more spacious, the dynamic range for setting the temperature of the passenger compartment has to make it possible also to set the temperature of the rear volume of the vehicle within a satisfactory period of time. In this case, an air resistance below 80 N.s.m⁻³ will be chosen.

As FIG. 2 shows, the air-diffusion element 1 may be a composite panel combining at least one said material, especially a textile 12 and a support 11, for example a rigid or semi-rigid support 11. The support 11 may be a frame onto which the permeable layer 12 is fixed. Alternatively, the support features through-apertures 14 including walls 15 which provide the mechanical properties of the assembly. This support 11 serves for the rigidity and the shaping of the panel thus constituted. The support 11 may be a grille, a perforated plate, or an alveolar material, for example a honeycomb, featuring through-alveoli. In that way, the air-diffusion element 1 integrates into the dashboard 3 visually as well as mechanically. The cross section of the end of the duct 16 has a surface area, for example, lying between 0.02 m² and 0.5 m², and preferably 0.04 m² and 0.2 m².

A main airflow F is diffused by a diverging air inlet 16, and the through-cells 14 perform a first subdivision of this flow parallel to their axis and these subdivided flows F′ then pass through the material 12, for example a textile, in order to perform the function sought.

The through-alveolus structure thus forms small channels enhancing the homogenization of the flows, and the loss of pressure head is due essentially to the material 12 (and/or 16).

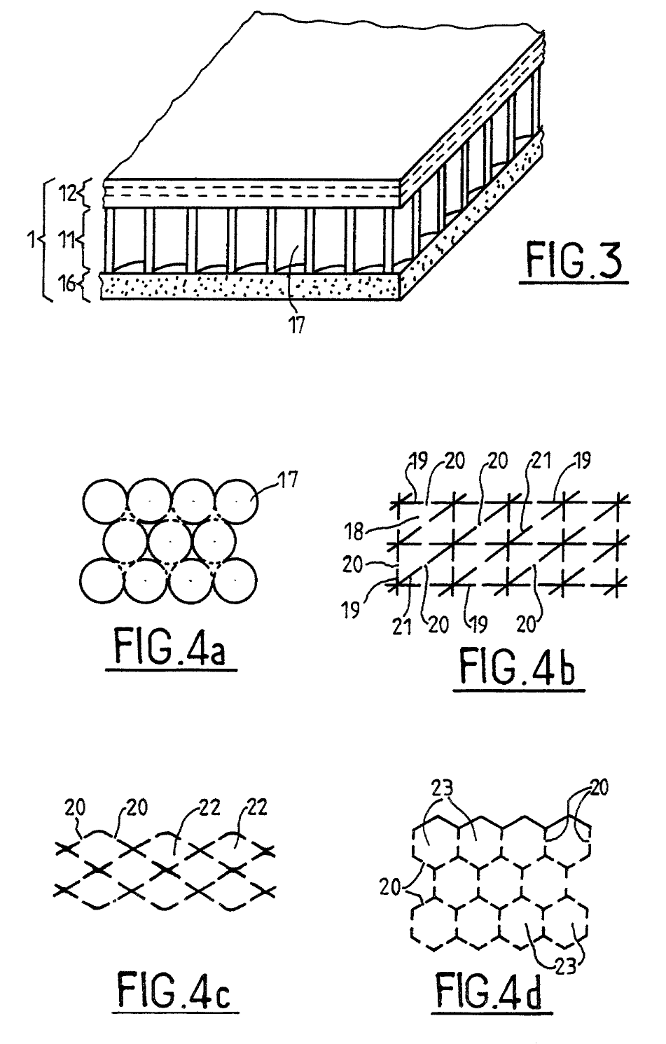

As FIG. 3 shows, the composite panel 1 may include two textile layers 12 and 16 on either side of the through-alveolus structure 11 which features through-apertures or cells 17. The cumulative air resistance at these two layers 12 and 16 lies between 10 N.s.m⁻³ and 180 N.s.m⁻³, and more particularly below 80 N.s.m³. This structure is advantageous, since it allows better stiffening of the assembly by reason of the fact that the films or textiles 12 and 16 are present on either side of the structure 11. This composite also features good acoustic-absorption characteristics, which means that the passengers perceive less noise from the heating, ventilation and/or air-conditioning device.

FIGS. 4a to 4d show different embodiments of the supports 11. In FIG. 4a, the cells are circular. In FIG. 4b, they have a rectangle/triangle shape, the sides 19 and hypotenuse 21 of which are provided with apertures 20, which allow the adjacent cells 18 to communicate. In FIG. 4c, the cells 22 are lozenge-shaped and are possibly provided with communication apertures 20 between adjacent cells. In FIG. 4d, hexagonal through-alveoli or apertures 23 have been represented, formed from a honeycomb structure. The walls of the cells 23 may feature communication apertures 20.

The composite panel may be manufactured in a simple way, bonding being carried out by thermal bonding and the forming of the composite being carried out by thermoforming.

One or more composite panels may be integrated into the dashboard and/or the roof and/or the rear shelf of a vehicle and/or in the doors.

Finally, FIG. 5 represents, as a function of the pressure difference ΔP expressed in Pascal and of the throughput in m³/h, the operating regions being for values of R≦180 N.s.m⁻³ and R≦80 N.s.m⁻³, respectively.

What we claim is:

1. A heating, ventilation and/or air-conditioning device including at least one air-distribution channel having a downstream end, and at least one air-diffusion element arranged at a said downstream end, wherein at least one air-diffusion element exhibits air resistance lying between 10 N.s.m⁻³ and 180 N.s.m⁻³.

2. The device of claim 1, wherein the said air resistance is below 80 N.s.m⁻³.

3. The device of claim 1, wherein the air-diffusion element includes a perforated plate, a grille, a cellular plastic with open pores or an alveolar material.

4. The device of claim 1, wherein the said air-diffusion element includes at least one textile.

5. The device of claim 4, wherein the said air-diffusion element includes a rigid or semi-rigid support for the said textile.

6. The device of claim 5, wherein the support features an air resistance no more than half of, and preferably at least ten times lower than, that of the said textile.

7. The device of claim 4, wherein the textile is woven.

8. The device of claim 4, wherein the textile is non-woven.

9. The device of claim 4, wherein the textile is multi-layered.

10. The device of claim 1, wherein at least one said air-diffusion element has a surface area lying between 0.02 m² and 0.5 m², and preferably 0.04 m² and 0.2 m².
